(19) United States
(12) Patent Application Publication
(10) Pub. No.: US 2015/0213522 A1
(43) Pub. Date: Jul. 30, 2015

(54) METHOD AND APPARATUS FOR OBTAINING CLIENT REVIEWS

(71) Applicant: Tencent Technology (Shenzhen) Company Limited, Shenzhen (CN)

(72) Inventor: Ding Gao, Shenzhen (CN)

(73) Assignee: TENCENT TECHNOLOGY (SHENZHEN) COMPANY LIMITED, Shenzhen (CN)

(21) Appl. No.: 14/682,919

(22) Filed: Apr. 9, 2015

Related U.S. Application Data
(63) Continuation of application No. PCT/CN2013/086106, filed on Oct. 29, 2013.

(30) Foreign Application Priority Data
Oct. 30, 2012 (CN) 201210424325.3

(51) Int. Cl. G06Q 30/02

(52) U.S. Cl. CPC G06Q 30/0282

(57) ABSTRACT

A method and apparatus for obtaining client reviews is provided. The method includes: obtaining a user's operation record; sending review invitation information to a corresponding client based on the operation record; receiving a review request comprising a review from the client, wherein the review request corresponds to the review invitation information; and matching the review in the review request with a review object. In accordance with the present method, a user will receive invitation information shortly after purchasing a product, receiving a purchased product, or using certain software, and can send the review through a variety of means, which enhances the user's interests in providing genuine and timely review; and the review is not limited to written review, but can also include audio review, which expands the scope of application.

### CROSS-REFERENCE TO RELATED APPLICATIONS

This application is a continuation of International Patent Application No. PCT/CN2013/086106, entitled “Method and Apparatus for Obtaining Client Reviews,” filed on Oct. 29, 2013. This application claims the benefit and priority of Chinese Patent Application No. 201210424325.3, entitled “Method and Apparatus for Obtaining Client Reviews,” filed on Oct. 30, 2012. The entire disclosures of each of the above applications are incorporated herein by reference.

### TECHNICAL FIELD

The present invention relates to Internet technologies, and more particularly to a method and apparatus for obtaining client reviews.

### BACKGROUND

After a user purchases a product from an e-commerce website and receives the product, the user can provide review for the purchased product. The existing methods for providing reviews for purchased products generally involves the following steps: the user logs into the e-commerce website, visits product webpage, enters review in an input box, and clicks “Submit Review” to submit the review to the system, which will ultimately be displayed and be available to other users. In the existing reviewing methods, the user need to visit the product webpage, submit review in an input box on the webpage, and click a button to submit the review.

The existing technology has the following drawbacks: (1) since the user need to visit the product webpage and submit a written review, the user's interest in providing review is low, and the review content is monotonous; (2) because the user initiates the review process in existing methods, there is often a substantial gap between the time the user receives the product and the time the user provides the review, which affects the quality of the review. Thus, there is a need to address these issues in the prior art.

### SUMMARY OF THE INVENTION

The present invention provides a method and apparatus for obtaining client reviews, which addresses the issue in the prior art where the user need to visit the product webpage and submit a written review, the user's interests in providing the review is low, and the review content is monotonous.

In accordance with embodiments of the present invention, a method for obtaining client review is provided, the method comprises: obtaining a user's operation record; sending review invitation information to a corresponding client based on the operation record; receiving a review request comprising a review from the client, wherein the review request corresponds to the review invitation information; and matching the review in the review request with a review object.

In accordance with embodiments of the present invention, an apparatus for obtaining client review is provided, the apparatus comprises an acquisition module, a sending module, a receiving module and a processing module, wherein the acquisition module is configured for obtaining a user's operation record; the sending module is configured for sending review invitation information to a corresponding client based on the operation record; the receiving module is configured for receiving a review request comprising a review from the client, wherein the review request corresponds to the review invitation information; and the processing module is configured for matching the review in the review request with a review object.

In accordance with embodiments of the present invention, based on a user's operation record, a review invitation is sent to the user shortly after the user purchases a product, or accepts or uses a purchased product. The user can send the review through a variety of means, including but not limited to submitting review in an input box on the product webpage, via text messaging, written instant messaging, and audio instant messaging, which makes it easier and enhances the user's interests in providing genuine and timely review. The review is not limited to written review, but can also include audio review, which expands the scope of application.

### BRIEF DESCRIPTION OF THE DRAWINGS

FIG. 1 is an exemplary flowchart for a method for obtaining client reviews in accordance with an embodiment of the present invention.

FIG. 2 is an exemplary flowchart for a method for obtaining client reviews in accordance with another embodiment of the present invention.

FIG. 3 is an exemplary schematic diagram for an apparatus for obtaining client reviews in accordance with yet another embodiment of the present invention.

FIG. 4 is an exemplary schematic diagram for an apparatus for obtaining client reviews in accordance with yet another embodiment of the present invention.

FIG. 5 is an exemplary flowchart for a method for obtaining client reviews in accordance with yet another embodiment of the present invention.

FIG. 6 is an exemplary flowchart for a method for obtaining client reviews in accordance with yet another embodiment of the present invention.

FIG. 7 is an exemplary flowchart for a method for obtaining client reviews in accordance with yet another embodiment of the present invention.

FIG. 8 is an exemplary flowchart for a method for obtaining client reviews in accordance with yet another embodiment of the present invention.

### DESCRIPTION OF THE PREFERRED EMBODIMENTS

The method and apparatus for providing client review in accordance with embodiments of the present invention will be further described in conjunction with the accompanying drawings. The client reviews obtained in accordance with embodiments of the present invention include client review of product purchased at e-commerce websites, review of software, and review of games, etc. In the following discussion, the term “client” may refer to, a client terminal device, which includes but is not limited to, a desktop computer, a laptop, a netbook, a tablet, a mobile phone, a multimedia TV and other electronic equipment, or a client side application program. To simplify the discussion, the various embodiments of the present will be discussed in connection with client review of product purchased at e-commerce websites, and the operational principle for obtaining other kind of reviews is the same as obtaining client review of product purchased at e-commerce websites.

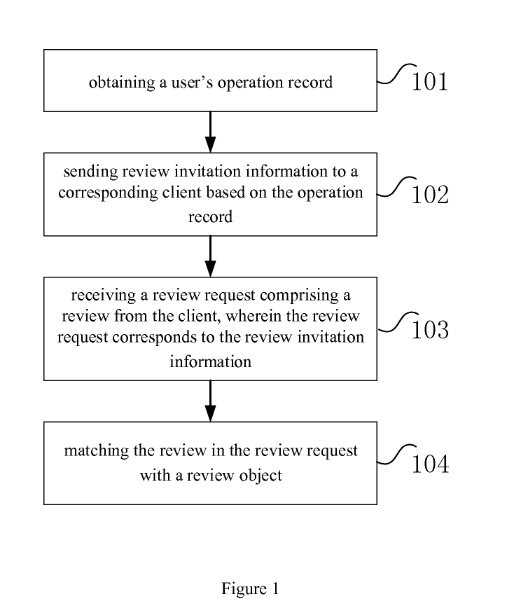

The method for providing client review in accordance with a first embodiment of the present invention will be further described in conjunction with the accompanying drawings. FIG. 1 is an exemplary flowchart for a method for obtaining client reviews in accordance with an embodiment of the present invention. As shown in FIG. 1, the method comprises the following steps:

Step 101: obtaining a user's operation record.

An e-commerce vendor may upload documents containing production information to a server of an electronic transaction system, and generate a hyperlink for the product information. The user can click the hyperlink to browse and purchase the corresponding product displayed on a display terminal. The server can also obtain the user's operation record at the display terminal, such as the login record, purchase record, product review record, and receipts of purchase or usage (such as checking in and checking out of a reserved hotel room). The user operation record can also be obtained by the electronic transaction platform, or provided by the service provider (such as a registration terminal of a hotel) or the logistic platform.

Step 102: sending review invitation information to a corresponding client based on the operation record. In this embodiment, the review invitation information is data relating to an invitation to review.

After the user completes the purchase, or accepts or uses the purchased products, the server sends review invitation information to the client corresponding to the user, such as the user's mobile terminal, tablet, PC or other clients. The review invitation information sent to the client can be written review invitation information, audio review invitation information, and review invitation email. The client can provide review by directly replying to the review invitation information. In another embodiment of the present invention, the server can obtain the type of the operation record, preset a prompt time based on the type of the operation record; and send review invitation information to the corresponding client after the prompt time. For example, if the user purchased a food voucher, review invitation information can be sent to a corresponding client of the user two hours after the food voucher is used. If the user reserved a hotel room, review invitation information can be sent to a corresponding client of the user at noon of the day after checking in, or when the user checks out. The server can send review invitation information to the client by sending a text message to the user's mobile phone, or by instant messaging to a user's mobile terminal or computer through the server's official enterprise account. Here, instant messaging (IM) is a real time communication service that allows the users to conduct private chat over the Internet.

The server can obtain the corresponding account of the client through matching based on the obtained user operation record. The client account may include mobile terminal phone number, instant messaging account, and email account. For example, during the purchase of the product, if the user provides contact information, such as mobile phone number, or log into the online shopping platform using an instant messaging account, the server can then matches the associated email address with the instant messaging account.

Step 103: receiving a review request comprising a review from the client, wherein the review request corresponds to the review invitation information.

In response to review invitation information sent by the server, the user can provide review directly through the client via text messaging, instant messaging, etc. Thus, the user does not need to log into the e-commerce website, visit the product webpage, and submit a written review, which makes it easier and enhances the user's interests in providing genuine and timely review. If the server sends review invitation information to a user's mobile phone (if a mobile phone number is matched), the user can directly provide review by replying a text message. If the server sends review written or audio invitation information to a user via instant messaging (if an instant messaging account is matched), the user can directly provide review in the chat window of the instant messenger, and the server receives a review request comprising a written or audio review in reply to the review invitation information from the client via instant messaging. After receiving the review request from the client, the server can store the review contained in the review request. The review can include written review, graphical review (a smiley face or an approving gesture), and audio review.

Step 104: matching the review in the review request with a review object.

After the server receives the review request containing the review from the client, it can automatically match the review with the review object (such as purchased product). After the matching, the review contained in the review request can be saved in a database so that it can be directly displayed when the user visits the product webpage next time.

In another embodiment, after matching the review in the review request with a review object, the review included in the review request sent by the client can also be examined based on a preset criterion, such as no disparaging or other sensitive words. In addition to product information, the display terminal can also display the review that meets the criterion so that it will be available to other users. In accordance with embodiments of the present invention, review invitation information is sent to the user, and the user can directly respond to the review invitation through a variety of means, which makes the obtained client review more genuine, timely, and useful.

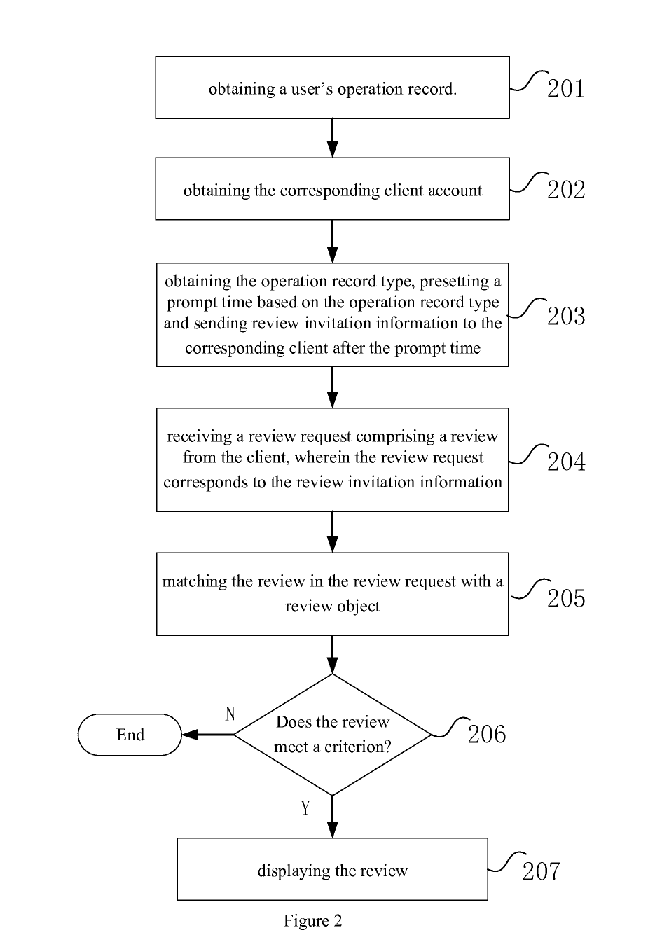

The method for providing client review in accordance with a second embodiment of the present invention will be further described in conjunction with the accompanying drawings. FIG. 2 is an exemplary flowchart for a method for obtaining client reviews in accordance with another embodiment of the present invention. As shown in FIG. 2, the method comprises the following steps:

Step 201: obtaining a user's operation record.

Step 202: obtaining the corresponding client account.

The server can obtain the corresponding account of the client through matching based on the obtained user operation record. The client account may include mobile terminal phone number and instant messaging account.

Step 203: obtaining a type of the operation record, presetting a prompt time based on the type of the operation record; and sending review invitation information to the corresponding client after the prompt time.

The server can obtain the type of the operation record, and preset a prompt time based on the type of the operation record. Based on the prompt time, the server can automatically send review invitation information to the corresponding client after the user purchases a product, or accepts or uses the purchased products, prompting the user that he/she can provide review by directly replying to the review invitation information. The server can send review invitation information to the client by sending a text message to the user's mobile phone, or by instant messaging to a user's mobile terminal or computer through the server's official enterprise account.

Step 204: receiving a review request comprising a review from the client, wherein the review request corresponds to the review invitation information.

In response to review invitation information sent by the server, the user can provide review directly through the client via text messaging, instant messaging, etc., which makes it easier and enhances the user's interests in providing genuine and timely review. If the communication terminal used by the user supports audio functionality, the user can provide an audio review via instant messaging, which is convenient and provides good user experience.

Step 205: matching the review in the review request with a review object.

After the server receives the review request containing the review from the client, it can automatically match the review with the review object (such as purchased product). After the matching, the review contained in the review request can be saved in a database so that it can be directly displayed when the user visits the product webpage next time. The review contained in the review request can include written review, graphical review (a smiley face or an approving gesture), and audio review.

Step 206: determining whether the review meets a criterion.

After the server obtains the review contained in the review request sent by the client, the server examines the review based on a preset criterion, such as no disparaging or other sensitive words. If the criterion is met, Step 207 is then performed; otherwise, the operation ends.

Step 207: displaying the review.

After the review meets the criterion, it can be displayed on the display terminal along the product information and be available to the users. If the review provided by the user is audio review, such as audio review via instant messaging, the server can display the audio review as a mouseover. In browsing the product webpage, the user can obtain the audio review by hovering the mouse over the audio review.

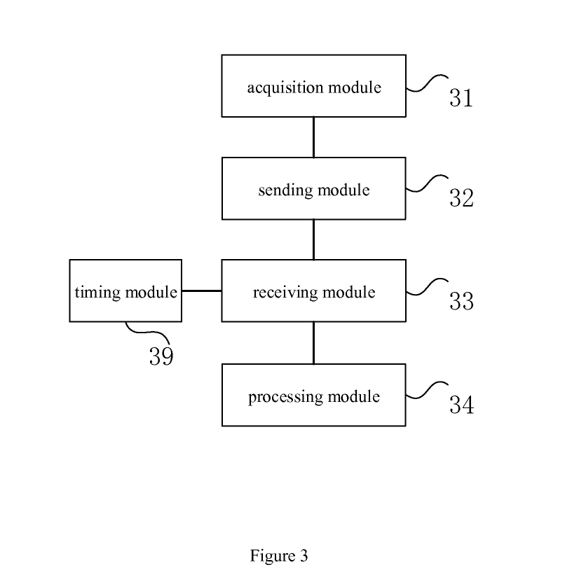

The apparatus for providing client review in accordance with a first embodiment of the present invention will be further described in conjunction with the accompanying drawings. FIG. 3 is an exemplary schematic diagram for an apparatus for obtaining client reviews in accordance with yet another embodiment of the present invention. As shown in FIG. 3, the apparatus comprises an acquisition module 31, a sending module 32, a receiving module 33 and a processing module 34.

The acquisition module 31 is used for obtaining a user's operation record.

The documents containing production information can be uploaded to a server of an electronic transaction system, and the server may generate a hyperlink for the product information. The user can click the hyperlink to browse and purchase the corresponding product displayed on a display terminal. The server can use the acquisition module 31 to obtain the user's operation record at the display terminal, such as the login record, purchase record, product review record, and receipts for purchase or usage (such as checking in and checking out of a reserved hotel room). The user operation record can also be obtained by the electronic transaction platform, or provided by the service provider (such as a registration terminal of a hotel) or the logistic platform.

The sending module 32 is used for sending review invitation information to a corresponding client based on the operation record.

After the user completes the purchase, or accepts or uses the purchased products, the sending module 32 sends review invitation information to the client corresponding to the user. The review invitation information sent to the client can be written review invitation information, audio review invitation information, and review invitation email, and prompts that the client can provide review by directly replying to the review invitation information. In another embodiment of the present invention, the apparatus further includes a timing module 39 connected to the sending module 32, and the timing module is used for obtaining a type of the operation record; presetting a prompt time based on the type of the operation record; start timing to the prompt time; and initiating the sending module 32 to send review invitation information to a corresponding client based on the operation record after the timing. The server can send review invitation information to the client by sending a text message to the user's mobile phone, or by instant messaging to a user's mobile terminal or computer through the server's official enterprise account.

The server can obtain the corresponding account of the client through matching based on the obtained user operation record. The client account may include mobile terminal phone number, instant messaging account, and email account.

The receiving module 33 is used for receiving a review request comprising a review from the client, wherein the review request corresponds to the review invitation information.

The review can include written review, graphical review (a smiley face or an approving gesture), and audio review.

The processing module 34 is used for matching the review in the review request with a review object.

After the processing module 34 receives the review request containing the review from the client, it can automatically match the review with the review object (such as purchased product). After the matching, the review contained in the review request can be saved in a database so that it can be directly displayed when the user visits the product webpage next time.

In another embodiment, after matching the review in the review request with a review object, the review included in the review request sent by the client can also be examined by the processing module 34 based on a preset criterion, such as no disparaging or other sensitive words. In addition to product information, the display terminal can also display the review that meets the criterion so that it will be available to other users.

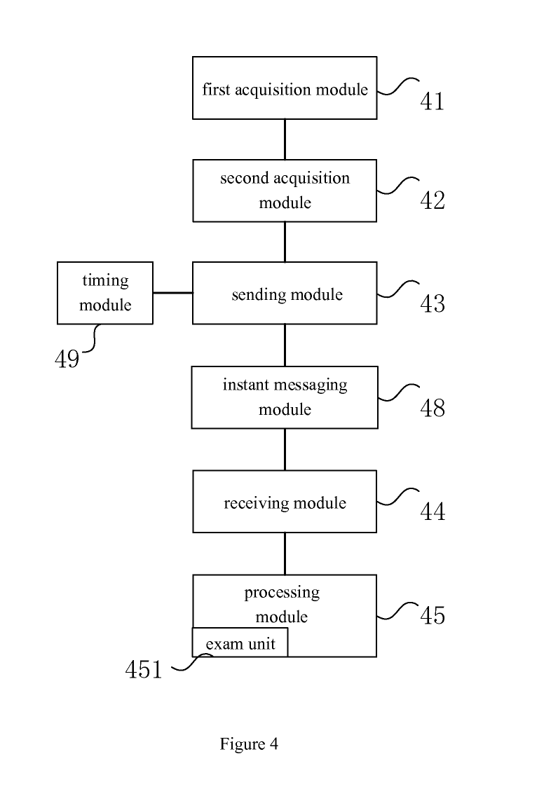

The apparatus for providing client review in accordance with a second embodiment of the present invention will be further described in conjunction with the accompanying drawings. FIG. 4 is an exemplary schematic diagram for an apparatus for obtaining client reviews in accordance with yet another embodiment of the present invention. As shown in FIG. 4, the apparatus comprises a first acquisition module 41, a second acquisition module 42, a sending module 43, a receiving module 44, a processing module 45, a timing module 49, and an instant messaging module 48.

The first acquisition module 41 is used for obtaining a user's operation record.

The second acquisition modul3 42 is use for obtaining the corresponding client account. The client account may include mobile terminal phone number and instant messaging account.

The timing module 49 is used for obtaining a type of the operation record, presetting a prompt time based on the type of the operation record; and initiating the sending module 43 to send review invitation information to the corresponding client after the prompt time.

The sending module 43 is connected to the instant messaging module 48 and the timing module 49, and is used for sending review invitation information via the instant messaging module 48 to the corresponding client after the prompt time set by the timing module 49.

The receiving module 44 is connected to the instant messaging module 48 and the processing module 45, and is used for receiving a review request comprising a review from the client via the instant messaging module 48, and sending the review request to the processing module 45, wherein the review request corresponds to the review invitation information. The review contained in the review request can include written review, graphical review (a smiley face or an approving gesture), and audio review.

The processing module 45 is used for matching the review in the review request with a review object.

After the server receives the review request containing the review from the client, the processing module 45 can automatically match the review with the review object (such as purchased product). The processing module 45 further includes an examination unit 451 for, after the server obtains the review contained in the review request sent by the client, examining the review based on a preset criterion, such as no disparaging or other sensitive words. If the review meets the criterion, it can be displayed on the display terminal along the product information so that it will be available to the users. If the review provided by the user is audio review, such as audio review via instant messaging, the processing module 44 can display the audio review as a mouseover. In browsing the product webpage, the user can obtain the audio review by hovering the mouse over the audio review.

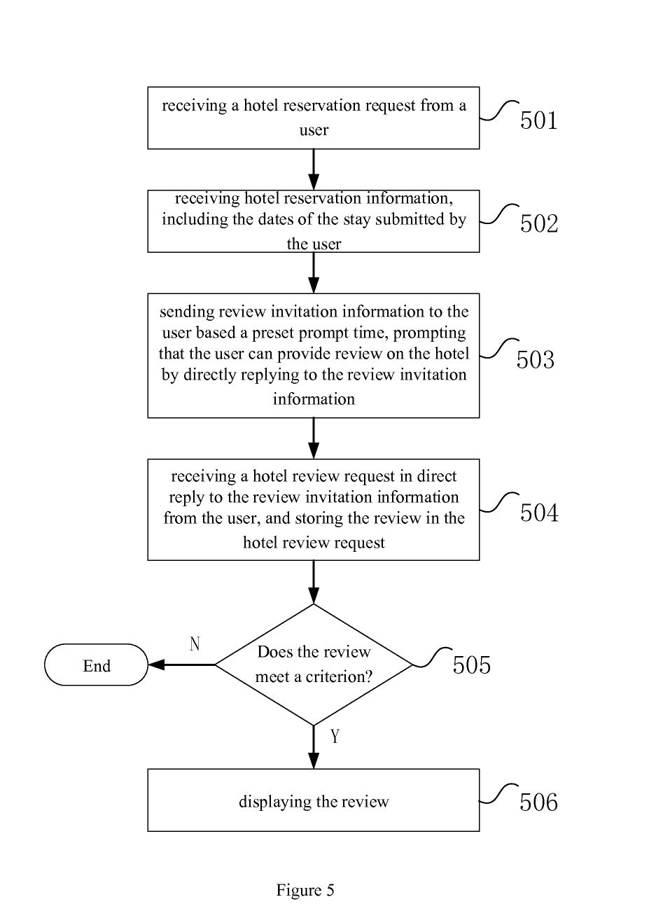

FIG. 5 is an exemplary flowchart for a method for obtaining client reviews in accordance with yet another embodiment of the present invention. In this embodiment, reserving hotel room is used as an example, and documents containing hotel information are uploaded to and saved by a server of an electronic transaction system, and a hyperlink address is generated.

Step 501: receiving a hotel reservation request from a user.

The user can log into the hyperlink address to browse and reserve the corresponding hotel, and the server will accept and record the request.

Step 502: receiving hotel reservation information, including the dates of the stay, submitted by the user.

Step 503: sending review invitation information to the user based a preset prompt time, prompting that the user can provide review on the hotel by directly replying to the review invitation information.

For example, if the check-in date for the reserved hotel is Aug. 17, 2012, the server can be set to send review invitation information to the user at noon of Aug. 18, 2012, prompting that the user can provide review by directly replying to the review invitation information so as to timely obtain the user's feedback on the reserved hotel. For example, the server can send the following message: “Dear Mr. ***. Thanks you for using ***. We would like to invite you to submit review for the *** Hotel that you reserved. We value your opinion on *** Hotel, and your review will help others to make a better choice.”

Step 504: receiving a hotel review request in direct reply to the review invitation information from the user, and storing the review in the hotel review request.

The user can directly reply to the review invitation information sent by the server to provide hotel review via text messaging, written instant messaging, or audio instant messaging. Providing review through instant messaging includes the following steps: the server sending review invitation information to the client's instant messaging account (if provided) through the server's official enterprise account; after the user providing written or audio review via instant messaging, the server automatically matching the provided review with the reserved hotel, and saving the review in a database.

Step 505: determining whether the review meets a criterion.

After the server obtains the review contained in the hotel review request sent by the client, the server examines the review based on a preset criterion, such as no disparaging or other sensitive words. If the criterion is met, Step 506 is then performed; otherwise, the operation ends.

Step 506: displaying the review.

After the server examines the review and determines that the review meets the criterion, the review provided by the user, including any audio review, will be displayed on the product webpage. If the review includes audio review, the audio review will be displayed as a mouseover.

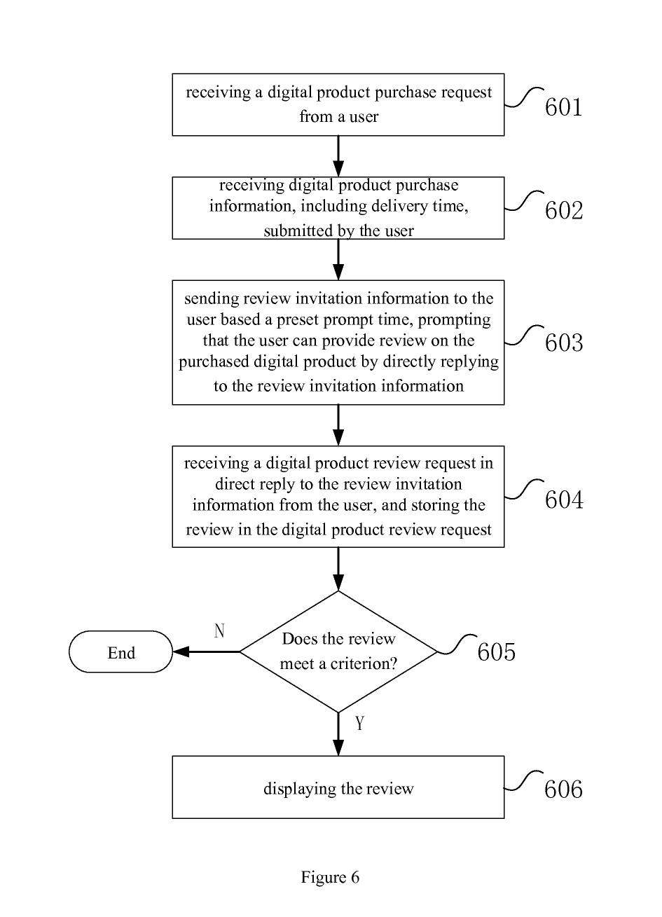

FIG. 6 is an exemplary flowchart for a method for obtaining client reviews in accordance with yet another embodiment of the present invention. In this embodiment, purchasing a digital product is used as an example, and documents containing digital product information are uploaded to and saved by a server of an electronic transaction system, and a hyperlink address is generated.

Step 601: receiving a digital product purchase request from a user.

The user can log into the hyperlink address to browse and purchase the corresponding digital product, and the server will accept and record the request.

Step 602: receiving digital product purchase information, including delivery time, submitted by the user.

Step 603: sending review invitation information to the user based a preset prompt time, prompting that the user can provide review on the purchased digital product by directly replying to the review invitation information.

For example, if the delivery time submitted by the user is a working day, and the expected delivery date of the digital product is Aug. 13, 2012, the server can be set to send review invitation information to the user on Aug. 20, 2012 (a week after the user receives the digital product), prompting that the user can provide review by directly replying to the review invitation information so as to timely obtain the user's feedback on the purchased digital product.

Step 604: receiving a digital product review request in direct reply to the review invitation information from the user, and storing the review in the digital product review request.

If the server sends the review invitation information in the form of a text message to the user's mobile phone, the user can provide review by directly reply to the text message. The server can also send review invitation information to the client's instant messaging account (if provided) through the server's official enterprise account; after the user provides written or audio review via instant messaging, the server automatically matches the review with the purchased digital product, and saving the review in a database.

Step 605: determining whether the review meets a criterion.

After the server obtains the review contained in the digital product review request sent by the client, the server examines the review based on a preset criterion, such as no disparaging or other sensitive words. If the criterion is met, Step 606 is then performed; otherwise, the operation ends.

Step 606: displaying the review.

After the server examines the review and determines that the review meets the criterion, the review provided by the user, including any audio review, will be displayed on the product webpage. If the review includes audio review, the audio review will be displayed as a mouseover.

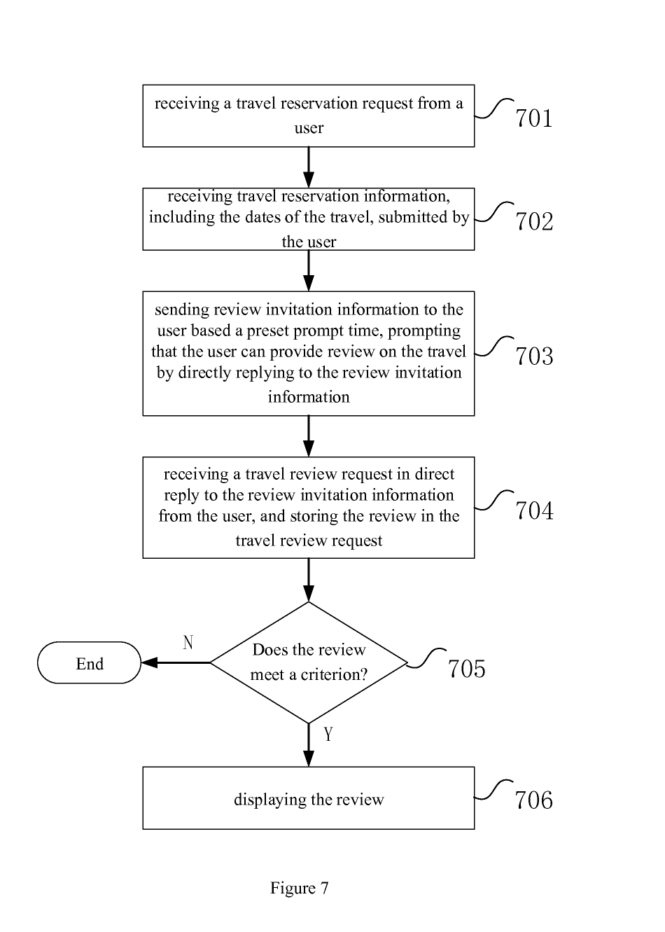

FIG. 7 is an exemplary flowchart for a method for obtaining client reviews in accordance with yet another embodiment of the present invention. In this embodiment, reserving travel is used as an example, and documents containing travel information, such as itinerary information are uploaded to and saved by a server of an electronic transaction system, and a hyperlink address is generated.

Step 701: receiving a travel reservation request from a user.

The user can log into the hyperlink address to browse and reserve the corresponding travel information, and the server will accept and record the request.

Step 702: receiving travel reservation information, including the dates of the travel, submitted by the user.

Step 703: sending review invitation information to the user based a preset prompt time, prompting that the user can provide review on the travel by directly replying to the review invitation information.

For example, if the starting date for the reserved travel is Aug. 17, 2012, and the travel will last two days, the server can be set to send review invitation information to the user on Aug. 20, 2012, prompting that the user can provide review on the travel by directly replying to the review invitation information so as to timely obtain the user's feedback on the reserved travel.

Step 704: receiving a travel review request in direct reply to the review invitation information from the user, and storing the review in the travel review request.

If the server sends the review invitation information in the form of a text message to the user's mobile phone, the user can provide review by directly reply to the text message. The server can also send review invitation information to the client's instant messaging account (if provided) through the server's official enterprise account; after the user provides written or audio review via instant messaging, the server automatically matches the review with the purchased digital product, and saving the review in a database.

Step 705: determining whether the review meets a criterion.

After the server obtains the review contained in the review request sent by the client, the server examines the review based on a preset criterion, such as no disparaging or other sensitive words. If the criterion is met, Step 706 is then performed; otherwise, the operation ends.

Step 706: displaying the review.

After the server examines the review and determines that the review meets the criterion, the review provided by the user, including any audio review, will be displayed on the product webpage. If the review includes audio review, the audio review will be displayed as a mouseover.

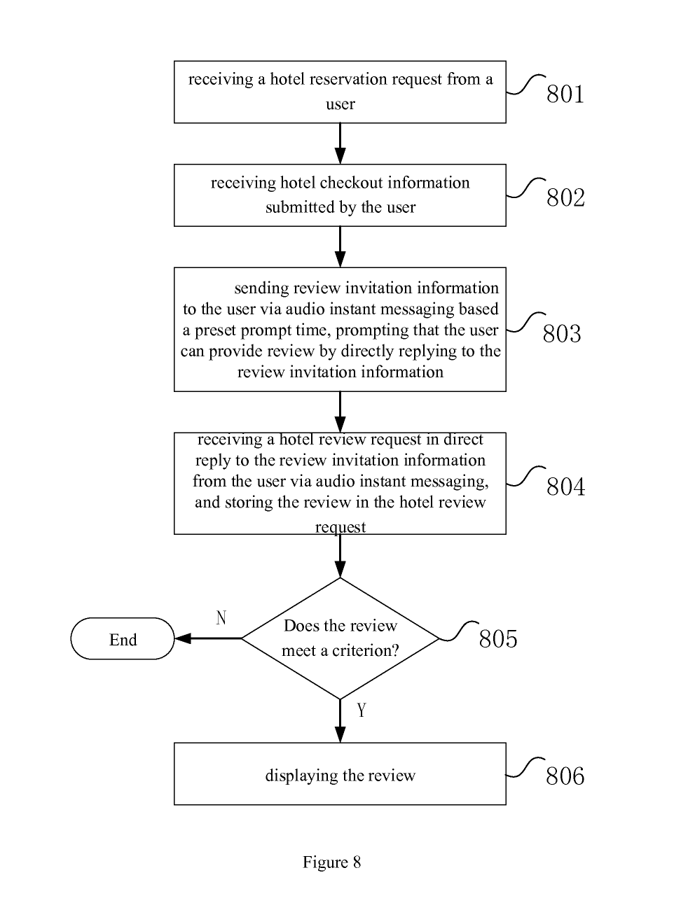

FIG. 8 is an exemplary flowchart for a method for obtaining client reviews in accordance with yet another embodiment of the present invention. In this embodiment, reserving hotel room is used as an example, and documents containing hotel information are uploaded to and saved by a server of an electronic transaction system, and a hyperlink address is generated.

Step 801: receiving a hotel reservation request from a user.

The user can log into the hyperlink address to browse and reserve the corresponding hotel, and the server will accept and record the request. The request can include the dates of the stay submitted by the user.

Step 802: receiving hotel checkout information submitted by the user.

After the stay, the user can check out of the hotel at an interactive device of the hotel, and a backend server of the interactive device can send the user's checkout information to the online platform of the electronic transaction system, prompting that the user has completed the transaction.

Step 803: sending review invitation information to the user via audio instant messaging based a preset prompt time, prompting that the user can provide review by directly replying to the review invitation information.

Step 804: receiving a hotel review request in direct reply to the review invitation information from the user via audio instant messaging, and storing the review in the hotel review request.

The user can directly reply to the review invitation information sent by the server to provide hotel review via audio instant messaging. The server automatically matches the review with the reserved hotel, and saving the review in a database.

Step 805: determining whether the review meets a criterion.

After the server obtains the review contained in the hotel review request sent by the client, the server examines the review based on a preset criterion, such as no disparaging or other sensitive words. If the criterion is met, Step 806 is then performed; otherwise, the operation ends.

Step 806: displaying the review.

After the server examines the review and determines that the review meets the criterion, the review provided by the user, including any audio review, will be displayed on the product webpage. If the review includes audio review, the audio review will be displayed as a mouseover.

In accordance with embodiments of the present invention, a review invitation is sent to the user shortly after the user purchases a product, or accepts or uses a purchased product. The user can send the review through a variety of means, including but not limited to submitting review in an input box on the product webpage, via text messaging, written instant messaging, or audio messaging, which makes it easier and enhances the user's interests in providing genuine and timely review. The review is not limited to written review, but can also include audio review, which expands the scope of application.

The various embodiments of the present invention are merely preferred embodiments, and are not intended to limit the scope of the present invention, which includes any modification, equivalent, or improvement that does not depart from the spirit and principles of the present invention.

1. A method for obtaining client reviews, the method comprising:
obtaining a user's operation record;
sending review invitation information to a corresponding client based on the operation record;
receiving a review request comprising a review from the client, wherein the review request corresponds to the review invitation information; and
matching the review in the review request with a review object.

2. The method of claim 1, wherein sending review invitation information to a corresponding client based on the operation record further comprises:
obtaining a type of the operation record;
presetting a prompt time based on the type of the operation record; and
sending review invitation information to the corresponding client after the prompt time.

3. The method of claim 1, wherein the review invitation information is selected from a group consisting of written review invitation information, audio review invitation information, and a review invitation email.

4. The method of claim 3, wherein sending review invitation information to a corresponding client further comprises sending written or audio review invitation information to the client via instant messaging, and receiving a review request comprising a review from the client further comprises receiving a review request comprising a written or audio review in reply to the review invitation information from the client via instant messaging.

5. The method of claim 1, wherein matching the review in the review request with a review object further comprises:
obtaining the review request comprising the review sent by the client;
examining the review based on a preset criterion; and
displaying the review on a display terminal if the review meets the criterion.

6. The method of claim 5, wherein the review is selected from a group consisting of a written review, a graphical review, and an audio review.

7. An apparatus for obtaining client reviews, the apparatus comprising an acquisition module, a sending module, a receiving module and a processing module, wherein
the acquisition module is configured for obtaining a user's operation record;
the sending module is configured for sending review invitation information to a corresponding client based on the operation record;
the receiving module is configured for receiving a review request comprising a review from the client, wherein the review request corresponds to the review invitation information; and
the processing module is configured for matching the review in the review request with a review object.

8. The apparatus of claim 7, wherein the review invitation information is selected from a group consisting of written review invitation information, audio review invitation information, and a review invitation email.

9. The apparatus of claim 7, further comprising a timing module for
obtaining a type of the operation record;
presetting a prompt time based on the type of the operation record;
start timing to the prompt time; and
sending review invitation information to a corresponding client based on the operation record after the timing.

10. The apparatus of claim 7, further comprising instant messaging module for sending written or audio review invitation information to the client via instant messaging, and receiving a review request comprising a written or audio review from the client in reply to the review invitation information from the client via instant messaging.

11. The apparatus of claim 7, wherein the processing module further comprises an examination unit for:
obtaining the review request comprising the review sent by the client;
examining the review based on a preset criterion; and
displaying the review on a display terminal if the review meets the criterion.

12. The apparatus of claim 11, wherein the review is selected from a group consisting of a written review, a graphical review, and an audio review.
